(19) United States
(12) Patent Application Publication
(10) Pub. No.: US 2011/0122050 A1
(43) Pub. Date: May 26, 2011

(54) LAPTOP COMPUTER

(76) Inventor: Jack William Mutlow, Pretoria (ZA)

(21) Appl. No.: 12/993,646

(22) PCT Filed: Mar. 20, 2009
(86) PCT No.: PCT/IB09/51181

§ 371 Date: Feb. 9, 2011

(30) Foreign Application Priority Data
May 21, 2008 (ZA) 2008/04363

(51) Int. Cl. G09G 5/00

(52) U.S. Cl. 345/1.3

(57) ABSTRACT

A laptop computer, which includes a body having a keyboard on an operative upper side thereof, a first display screen hingedly connected to one side of the body, the display screen hingedly displaceable between a stowed condition in which a display area is directed towards the keyboard, and an operative condition in which the display area is at an approximate right angle to the keyboard directed across the keyboard panel, and a second display screen, co-planar with, and back to back, with the first display screen, and displaceable in unison therewith, between a stowed condition in which a display area is directed away from the keyboard, and an operative condition in which the display area is at an approximate right angle to the keyboard directed away from the keyboard.

### BACKGROUND OF THE INVENTION

The inventor is aware of display arrangements comprising multiple display screens. However, none of the available display assemblies provide for simultaneous viewing of the same information from opposed viewing positions. The present invention aims to address this shortcoming.

### SUMMARY OF THE INVENTION

According to one aspect of the invention, there is provided a laptop computer, which includes

a body having a keyboard on an operative upper side thereof;

a first display screen hingedly connected to one side of the body, the display screen hingedly displaceable between a stowed condition in which a display area is directed towards the keyboard, and an operative condition in which the display area is at an approximate right angle to the keyboard directed across the keyboard panel; and

a second display screen, co-planar with, and back to back, with the first display screen, and displaceable in unison therewith, between a stowed condition in which a display area is directed away from the keyboard, and an operative condition in which the display area is at an approximate right angle to the keyboard directed away from the keyboard.

The laptop computer may include an electronic display interface having at least one display input and two display outputs each of which is electrically connected to the first- and the second display screens respectively, the display interface operable selectively to switch the at least one display input to any one or both of the display outputs.

The at least one display input may be switched simultaneously to the two display outputs like a display signal splitter, operable simultaneously to feed the two display screens with the same display signals.

The laptop computer may include at least two display inputs for receiving a first set of display information into a first display input and a second set of display information into a second display input, the display interface operable selectively to switch any one of the two display inputs to any one or both of the display outputs, for displaying any one of the first- and second sets of display information on any one of the first-, and second display screens.

Importantly, the first- and the second sets of display information must be oriented in an upright condition when the first and second display screens are in an operative condition. Importantly, in operation the two display screens may be viewed from two opposite viewing positions.

The two display screens may substantially have the same dimensions.

The first-, and second display screens may be any one of a Liquid

Crystal Display (LCD), a Light Emitting Diode (LED) display, an Organic Light Emitting Display (OLED), an Electro Luminescent Display (ELD), a plasma display, or a Thin Film Transistor (TFT) Liquid Crystal Display (LCD).

The display screens may be operable to display any type of information such as video images, computer graphic images, static images, or the like.

In one embodiment, the laptop computer may include a video camera, directed in the same direction as the first display screen. In another embodiment, the laptop computer may include a video camera, directed in the same direction as the second display screen.

The laptop computer may include at least one stand below the body on the same side of a hinge between the body and the first display screen.

The at least one stand may be foldable between a stowed condition in which a hinge side of the body is substantially planar to a support surface and an operative condition in which the hinge side of the body is raised above the support surface. Advantageously, the stand may be used in operation to raise the display screens above a support surface for ease of viewing of the screens, when the first display screen is in an operative condition.

The invention will now be described, by way of example only with reference to the following drawing(s):

### DRAWING(S)

In the drawing(s):

FIG. 1 shows a front view of a laptop computer according to one aspect of the invention; and

FIG. 2 shows a rear view of the laptop computer of FIG. 1.

### EMBODIMENT OF THE INVENTION

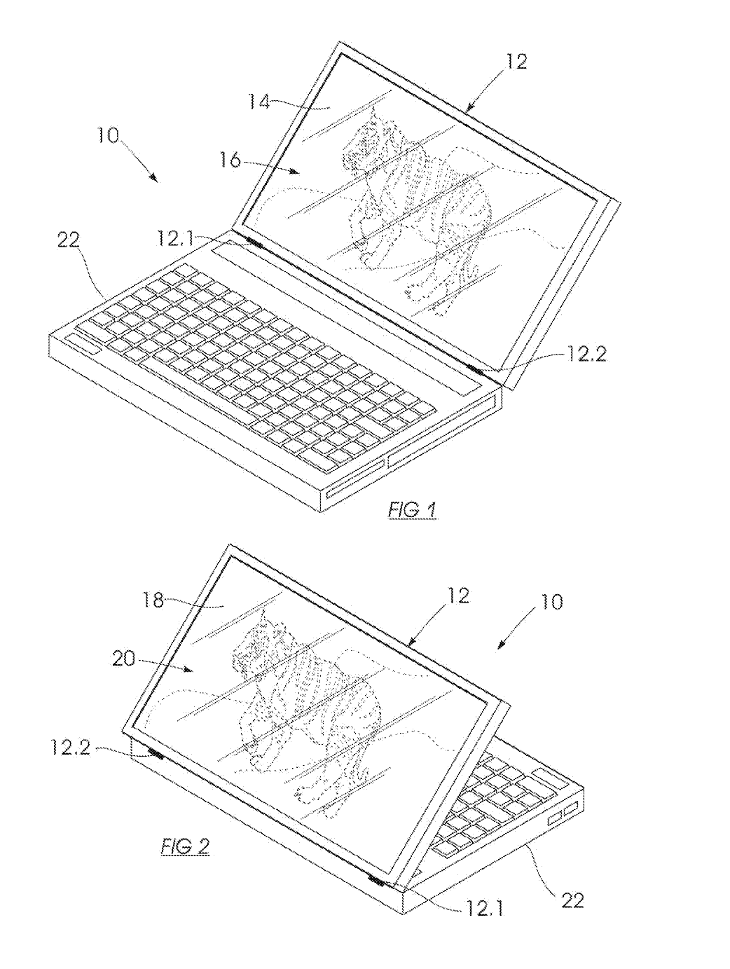

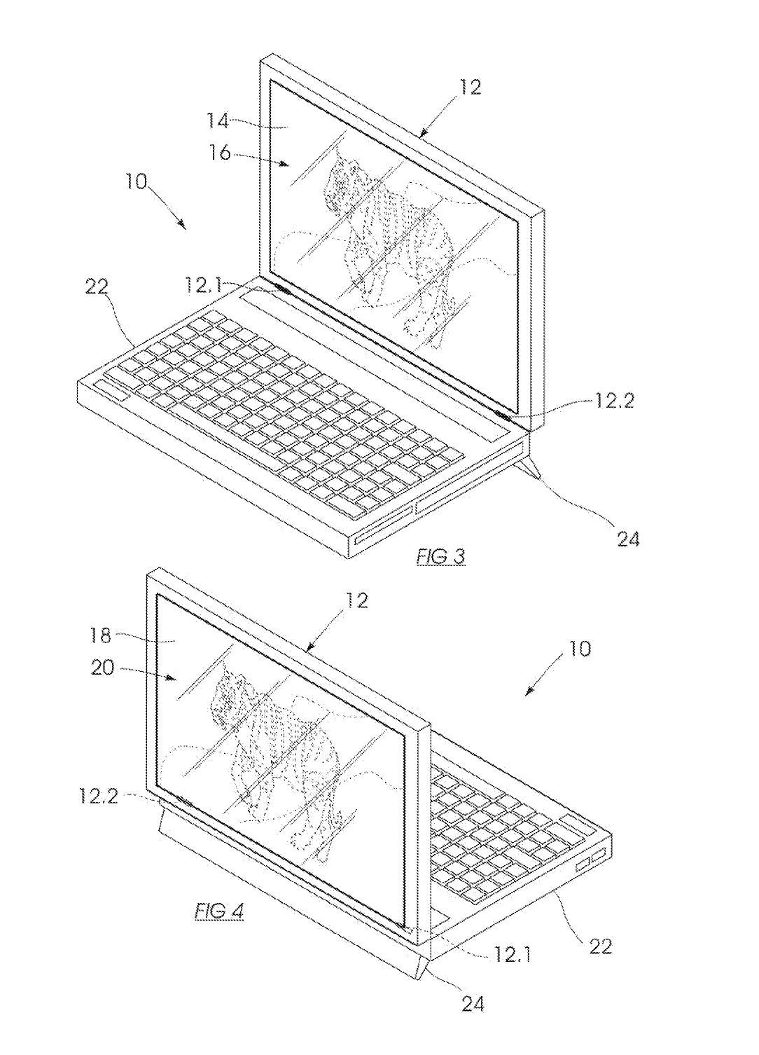

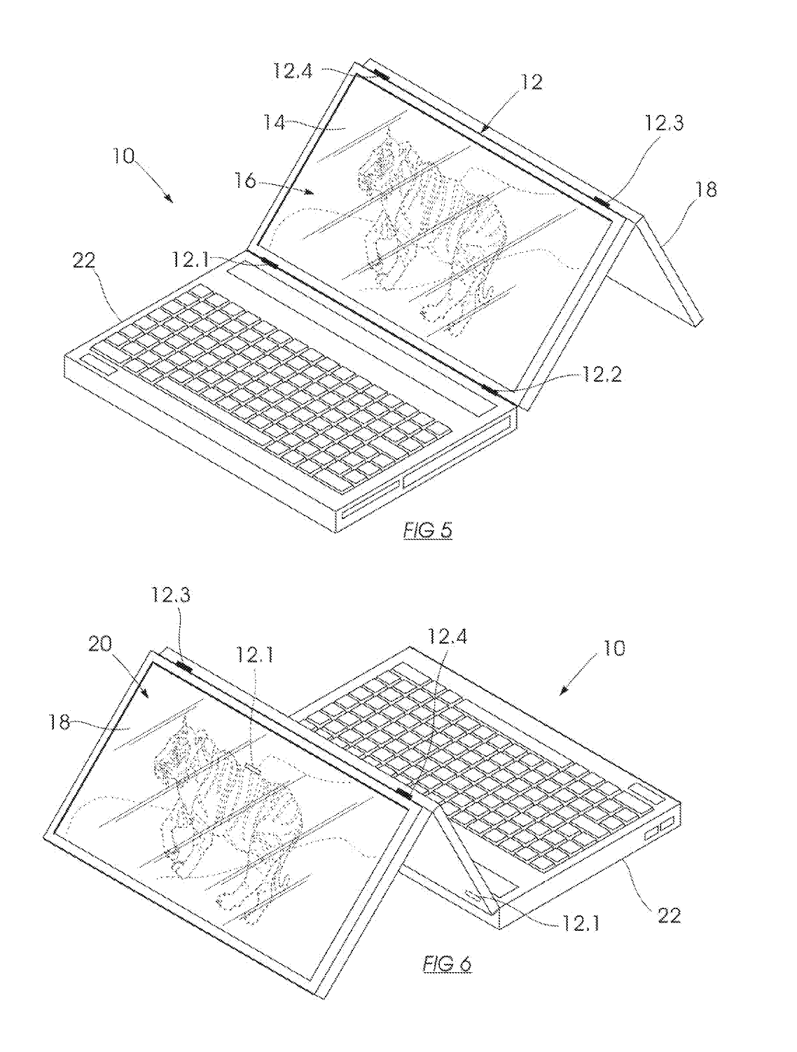

FIG. 1 shows a front view of a laptop computer 10 according to one aspect of the invention. The laptop computer includes a display assembly 12 having a first display screen 14 operable to display a first set of information 16 and a second display screen 18 (see FIG. 2), co-planar with and back to back with the first display screen 14 operable to display a second set of information 20 (see FIG. 2).

The display assembly 12 is provided with two hinges, 12.1, 12.2 for connecting the display assembly 12 incorporating the first and second display screens 14, 18 hingedly to a body 22 of the laptop 10.

In this embodiment, the first display screen 14 and the second display screen 18 operate as normal dual displays of the laptop computer 10. The screen drivers of the laptop computer provide for switching of the information 16, 20 to be displayed on the displays 14, 18. The information 16, 20 can be selected by the display drivers to be the same information, or may be selected to be different information. For example, if the information 16, 20 is the same on both displays 14, 18, the laptop computer may be used to display the same information to a larger audience sitting opposite the laptop computer operator. If the information 16, 20 is different, an operator may for example display a presentation to an audience viewing the information 20 on the second display screen 18, while viewing notes 16 of the presentation on the first display screen 14.

Apart from the display driver, the laptop computer 10 operates like a regular laptop computer.

The display screen 20 can be provided with a protective cover (not shown), shaped and dimensioned to cover the display screen when not in use.

In another embodiment, the laptop computer 10 can be provided with a second keyboard instead of the cover, the keyboard foldable between a protective position in which the display screen 20 is covered and an open position in which the keyboard is usable by a second operator.

Furthermore any one or both of the display screens can be provided with a camera operable to capture video images in an opposite direction of the normal viewing directions of the screens 16, 20.

In a particular embodiment in FIGS. 3 and 4, the laptop 10 includes at least one foldable stand 24 below the body on the same side of the hinges 12.1, 12.2 between the body 22 and the display assembly 12. In use, the foldable stand may raise the first- and second display screens 14, 18 above a support surface to ease viewing of the two displays, without having to adjust the view angle of any one of the display screens. Obviously, when both opposed display screens are viewed simultaneously, the view angle cannot be adjusted on one display without compromising the view angle of the other display. Therefore, the preferred display angle is at a right angle to a support surface as indicated in FIGS. 3 and 4.

In another embodiment in FIGS. 5 and 6, the second display 18 is be provided with a second set of hinges 12.3, 12.4 at an apposed side to the first set of hinges 12.1, 12.2 so that the first display 14 can be adjusted to an obtuse angle to a support surface by means of the first set of hinges 12.1, 12.2 and the second display 18 can also be adjusted to an obtuse angle to the support surface by means of the second set of hinges 12.3, 12.4.

The inventor believes that the invention can be of particular use in the viewing of information by an audience sitting opposite an operator of display device or a laptop computer. The invention can be of particular use in a presentation to an audience, to a group of students being taught, in medical applications, as billboards, in navigational systems and in a video recording arrangement where a subject being recorded can view himself/herself.

1. A laptop computer, which includes
a body having a keyboard on an operative upper side thereof;
a first display screen hingedly connected to one side of the body, the display screen hingedly displaceable between a stowed condition in which a display area is directed towards the keyboard, and an operative condition in which the display area is at an approximate right angle to the keyboard directed across the keyboard panel; and
a second display screen, co-planar with, and back to back, with the first display screen, and displaceable in unison therewith, between a stowed condition in which a display area is directed away from the keyboard, and an operative condition in which the display area is at an approximate right angle to the keyboard directed away from the keyboard.

2. A laptop computer as claimed in claim 1, which includes an electronic display interface having at least one display input and two display outputs each of which is electrically connected to the first- and the second display screens respectively, the display interface operable selectively to switch the at least one display input to any one or both of the display outputs.

3. A laptop computer as claimed in claim 2, which includes at least two display inputs for receiving a first set of display information into a first display input and a second set of display information into a second display input, the display interface operable selectively to switch any one of the two display inputs to any one or both of the display outputs, for displaying any one of the first- and second sets of display information on any one of the first-, and second display screens.

4. A laptop computer as claimed in claim 1, in which the two display screens substantially have the same dimensions.

5. A laptop computer as claimed in claim 1, in which the first-, and second display screens are any one of a Liquid Crystal Display (LCD), a Light Emitting Diode (LED) display, an Organic Light Emitting Display (OLED), an Electro Luminescent Display (ELD), a plasma display, or a Thin Film Transistor (TFT) Liquid Crystal Display (LCD).

6. A laptop computer as claimed in claim 1, which includes a video camera, directed in the same direction as the first display screen.

7. A laptop computer as claimed in claim 1, which includes a video camera, directed in the same direction as the second display screen.

8. A laptop computer as claimed in claim 1, which includes at least one stand below the body on the same side of a hinge between the body and the first display screen.

9. A laptop computer as claimed in claim 8, in which the at least one stand is foldable between a stowed condition in which a hinge side of the body is substantially planar to a support surface and an operative condition in which the hinge side of the body is raised above the support surface.
